(19) United States
(12) Patent Application Publication
(10) Pub. No.: US 2007/0127928 A1
(43) Pub. Date: Jun. 7, 2007

(54) Large field of view modulating retro reflector (MRR) for free space optical communication

(75) Inventors: Deepak Varshneya, Del Mar, CA (US); Chris Taylor, Cardiff, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cubic Corporation, San Diego, CA (US)

(21) Appl. No.: 11/295,849

(22) Filed: Dec. 7, 2005

(51) Int. Cl. H04B 10/00

(52) U.S. Cl. 398/135

(57) ABSTRACT

A modulating retro-reflector (MRR) can be configured to provide a large field of view. The MRR can include a solid corner cube reflector (CCR) manufactured of a material having a high index of refraction at the desired operating wavelength. CCRs made from high index materials such as InP or Si, have an index of refraction of approximately 3.48 at an operating wavelength of approximately 1550 nm and can provide a conical Field of View (FOV) of greater than ±60 degrees compared to less than ±30 degrees for CCRs made from BK-7. Each CCR can include one or more elements configured to modulate an optical signal incident on the CCR. A retro-modulating transponder can use fewer large FOV MRRs to support communication over a predetermined incident optical span compared to narrower FOV MRRs resulting in lower cost, smaller size, weight and power requirements.

### BACKGROUND OF RELATED ART

Optical communication systems are advantageously implemented to support communications in a variety of operational situations. An optical communication system can offer many features and advantages not available from other systems. An optical communication system can typically provide an information bandwidth not available from other communication systems. A free space optical communication system can provide a line of sight link without the need to establish any wired infrastructure between the access points of the link. A free space optical communication link typically utilizes highly directional narrow divergence laser beams, thereby minimizing the opportunity for detection or interception of the signals and receivers that may have relatively narrow field of view (FOV), limiting the amount of noise and interference received from undesired or unintentional optical sources.

Some aspects of an optical communication system that may be advantageous in an application may present a problem in another. For example, the highly directional narrow laser beam associated with a free space laser transmitter can present problems of initially aligning the communication link or potentially maintaining connectivity in mobile communication environments. On the other hand, narrower divergence laser beams provide longer communication ranges compared to broader divergence beams for a given source power.

An optical communication system typically employs an optical transmitter and a receiver that could present portability issues in a mobile communication system. An optical source may be a laser or other substantially coherent optical source having a relatively large physical size/weight requiring a relatively larger amount of electrical power. This would reduce the applicability in mobile communication systems because it would be difficult to transported by an individual.

Optical hardware, such as lenses, gratings, or filters, or additional lasers/receivers may also have a substantial physical size. Additionally, such hardware may not be sufficiently rugged for a mobile environment. An optical transmitter or receiver may also require mechanical mounts for maintaining the relationship with various optical components. The weight of optical hardware and mechanical supports may also limit the appeal of optical communications for mobile communications.

It is desirable to reduce size, weight and power of optical communication link hardware or improve the associated technologies in order to further capitalize on the advantages and features available from optical communication systems.

### BRIEF SUMMARY

Embodiments of a modulating retro-reflector (MRR) configured to provide a large field of view and a transponder using one or more MRRs is disclosed. The MRR can include a solid corner cube reflector (CCR) manufactured of a material having a high index of refraction at the desired operating wavelength. The high index materials can include Indium Phosphide (InP) or monocrystalline optical grade Silicon (Si), and can provide an index of refraction of greater than 1.5 or greater than 3 and approximately 3.4 at an operating wavelength of approximately 1550 nm. Each CCR can include one or more elements configured to modulate an optical signal incident on the CCR. The modulating element can be positioned on the front surface of the CCR or can be positioned on one or more of the back, or reflecting, surfaces of the CCR.

A retro-modulating transponder (tag) can use fewer large field of view MRRs to support communication over a predetermined incident optical span. A transponder can utilize as few as three Si or InP CCRs to support communications over 360 degrees in azimuth and 180 degrees in elevation.

Disclosed is a modulating retro-reflector including a corner cube reflector comprising an index of refraction greater than approximately 1.5 at an operating wavelength, such as 1550 nm, and an optical modulator positioned relative to the entrance aperture of the corner cube reflector and configured to modulate a signal incident on the face of the corner cube reflector.

Also disclosed is an optical transponder/tag including a modulating retro-reflector (MRR) comprising a corner cube reflector having an index of refraction greater than about 3.0 at a wavelength of interest, and configured to selectively modulate an incident optical pulsed signal having the wavelength of interest. The transponder includes a wide FOV optical receiver configured to receive the incident optical signal and determine presence of a predetermined signal, and a modulator coupled to the optical receiver and configured to modulate the MRR when the optical receiver determines that the incident signal includes the predetermined signal.

Disclosed is a method of operating a transponder in an optical communication system that includes receiving an incident optical signal at an optical receiver, determining presence of a predetermined signal in the incident optical signal, receiving an incident optical signal at the face of a corner cube reflector having an index of refraction greater than about 3.0, and modulating the incident optical signal using an optical modulator positioned relative to the entrance face of the corner cube reflector to produce a modulated reflected signal, if the predetermined signal is present in the incident optical signal.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a simplified functional block diagram of an embodiment of an optical communication system.

FIG. 2 is a simplified functional block diagram of an embodiment of a tag having a modulating retro-modulator.

FIG. 3 is a simplified diagram of an embodiment of a modulating retro-reflector having a high index of refraction corner cube reflector.

FIG. 4 is a simplified diagram of an embodiment of a modulating retro-reflector having a high index of refraction corner cube reflector.

FIG. 5 is a simplified diagram of an embodiment of a corner cube implementation supporting a wide coverage area.

FIG. 6 is a flowchart of an embodiment of a method of configuring an optical receiver.

FIG. 7 is a graph illustrating peak intensity loss vs. incident angle for embodiments of corner cube reflectors.

### DETAILED DESCRIPTION OF EMBODIMENTS OF THE INVENTION

A Modulating Retro-Reflector for use in optical communication systems can be configured to have a wide Field Of View (FOV). A large FOV modulating retro-reflector can be used to provide substantially angle independence reception of directional laser beams. A transponder/tag utilizes fewer wide FOV modulating retro-reflectors to support a predetermined coverage. Each of the modulating retro-reflectors can be configured to include a solid Comer Cube Reflector (CCR) manufactured of a high index of refraction material. Such high index of refraction material refers to an index of refraction greater than about 1.5 at the operating wavelength. However, the high index of refraction may be greater than about 1.75, 2.0, 2.25, 2.5, 2.75, 3.0, 3.25, 3.5, or some other index of refraction value.

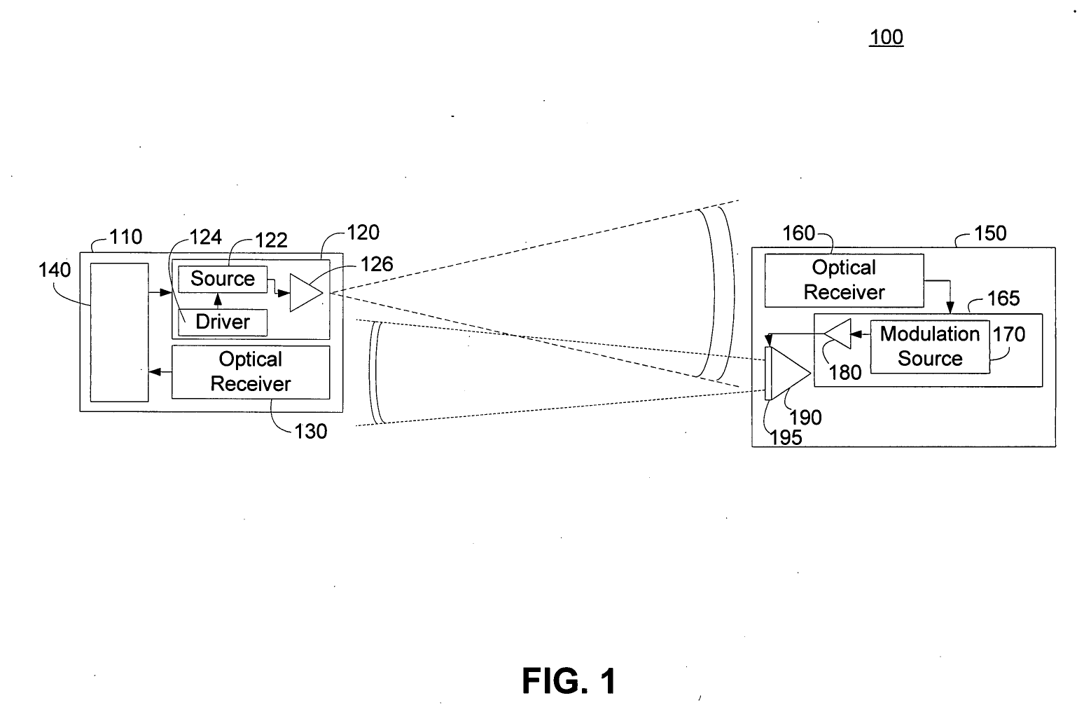

FIG. 1 is a simplified functional block diagram of an embodiment of a free space optical system 100 that can utilize the disclosed optical source and method of generating a modulated carrier signal. Although the free space optical communication system 100 of FIG. 1 is illustrated as a system that transmits information through the use of retro-modulation, use of retro-modulation is not a limitation of a free space optical communication system 100. Another embodiment of the free space optical communication system 100 can use independent transceivers that each includes receivers and optical sources, and retro-modulation of an incident signal can be omitted. Other embodiments of the free space optical communication system 100 can be configured for unidirectional information transfer. In such an embodiment, an optical source may be configured to transmit a coded optical signal across a free space optical channel to one or more optical receivers, which may not have the ability to transmit optical signals.

The optical communication system 100 can include a first transceiver 110 that is configured to generate a modulated optical signal. The modulated optical signal can be transmitted to a second transceiver 150, for example, via a free space communication channel. The second transceiver 150 can be configured to receive the optical signal and can be configured to generate a return coded optical signal. In the configuration shown in FIG. 1, the second transceiver 150 is configured to include a retro-modulator that can operate to modulate and code the incident carrier signal.

The first transceiver 110 can include an optical transmitter 120 configured to generate an outgoing optical signal and an optical receiver 130 configured to receive the retro-modulated optical signal, or some other received optical signal. The optical transmitter 120 can include an optical source 122 that can include a laser. Embodiments of the optical source 122 are discussed in more detail below.

The output of the optical source 122 can be controlled by a driver 124 that can be configured to modulate the optical signal by modulating the laser drive current. For example, the driver 124 can be configured to pulse the current to the optical source 122 to create a pulsed optical output sign al. The driver 124 can be configured to receive a first modulation signal from a first data source, such as a data and control module 140. The first modulation signal can be, for example, data or information that is to be sent to a receiver 160 local to the second transceiver 150.

The modulated optical signal can be coupled from the optical source 122 to an optical amplifier 126 that can be configured to amplify the modulated optical signal before coupling the transmit signal to the appropriate communication channel.

The second transceiver 150 can be configured to receive the modulated optical signal over the communication channel. In the embodiment shown in FIG. 1, the second transceiver 150 includes a wide FOV receiver 160 coupled to a retro-modulator and modulator drive module 165. The modulator drive module 165 can include a modulation data source 170. The retro-modulator can include a corner cube reflector 190 that has an optical modulator 195 mounted on the front entrance aperture of the corner cube reflector 190.

In retro-modulation communication, the optical source/transmitter is placed at the first transceiver 110 end referred to as an Interrogator (INT). A CCR 190 and a modulator 195 are placed at the second transceiver 150 or the Tag. In a tactical optical communication system, such as Dynamical Optical Tags (DOTs), a laser Interrogator searches for a Tag consisting of a single or multiples of retro reflectors and optical receivers. Employing wide FOV MRRs and optical receivers reduces the total number required for a given FOV. This system architecture reduces the Tag form factor and electrical power requirements because there is no optical source at the Tag. The combined CCR 190 and modulator 195 device is typically referred to as a Modulating Retro Reflector (MRR). The geometrical and optical CCR 190 architecture can ensure that all incoming beams and reflected beams are parallel and travel substantially the same optical distance through the CCR 190 so that the interrogator can properly detect and process the retro-modulated signal.

The receiver 160 can be configured to receive the pulsed optical signal from the optical channel and can recover the first modulation signal. The receiver 160 can determine, for example, if at least a portion of the first modulation signal corresponds to a predetermined signal or sequence. The receiver 160 can also recover information and data that is included in a portion of the first modulation signal. If the receiver 160 determines that the received signal corresponds to the predetermined signal or sequence, the receiver 160 can activate the retro-modulator and can control the modulation drive module 165 to modulate the received optical signal using the second modulation signal provided by the modulation data source 170.

The modulation data source 170 can, for example, drive an amplifier 180 with a modulation signal that is provided to the quantum well modulator 195 positioned on the front entrance surface of the corner cube reflector 190 to retro-modulate the incident carrier signal. The retro-modulator can modulate the incident optical carrier signal with the second modulation signal and can reflect the modulated optical signal back along the direction of the incident optical signal. In this manner, the second transceiver 150 is not required to include an optical signal source.

In one embodiment, the optical communication system 100 can be configured as a Dynamic Optical Tag (DOT) system that can also be configured as an Identification as Friend-or-Unknown Combat Identification (CID) system for use in a battlefield or in combat training. Examples of such CID optical systems are provided in U.S. patent application Ser. No. 10/066,099 filed Aug. 7, 2003, assigned to the assignee of the present application, and hereby incorporated herein by reference in its entirety.

In a combat identification as friend or unknown system, the first transceiver 110 can be a combat interrogatory unit that can be positioned in a weapon-mounted disposition. A challenging soldier may target a second transceiver 150 positioned on a target. In one embodiment, the second transceiver 150 can be a helmet-mounted combat response unit worn by a soldier in a combat training exercise or in actual combat.

An infrared (IR) transmit signal can be projected by an optical source upon operator command. The transmit signal radiates outward along a narrow beam, eventually illuminating the response unit. For example, the transmit signal may be embodied as a half milliradian beam or less of Infrared (IR) light. This beam illuminates an area of about 0.5 meter on a side at a typical weapon range limit of 1000 meters. Beam could be dithered at a rapid rate to cover a larger target size.

Upon being received, detected and verified at the response unit, the transmit signal can be retro-reflected back to the interrogatory unit as a response signal. For a 0.5 milliradian transmit signal, a response signal can include a reflection of, for example, a 6.3 mm portion of the 0.5 meter transmit beam. This 6.3 mm reflected portion can include about 0.002 percent (−47 dB) of the initial energy of transmit signal. This energy can be generally reflected back to interrogatory unit by a precision retro-reflector. Response signal can be received at interrogatory unit reduced by an additional transmission loss of typically −8 dB, which leaves sufficient power for the CID detection and processing at interrogatory unit. The IR wavelength is provided merely as an example, although such a wavelength may be preferred because it is considered to be eye-safe and has relatively low absorption and scattering loss in the battlefield smoke and haze and obscurations such as rain, snow, and fog.

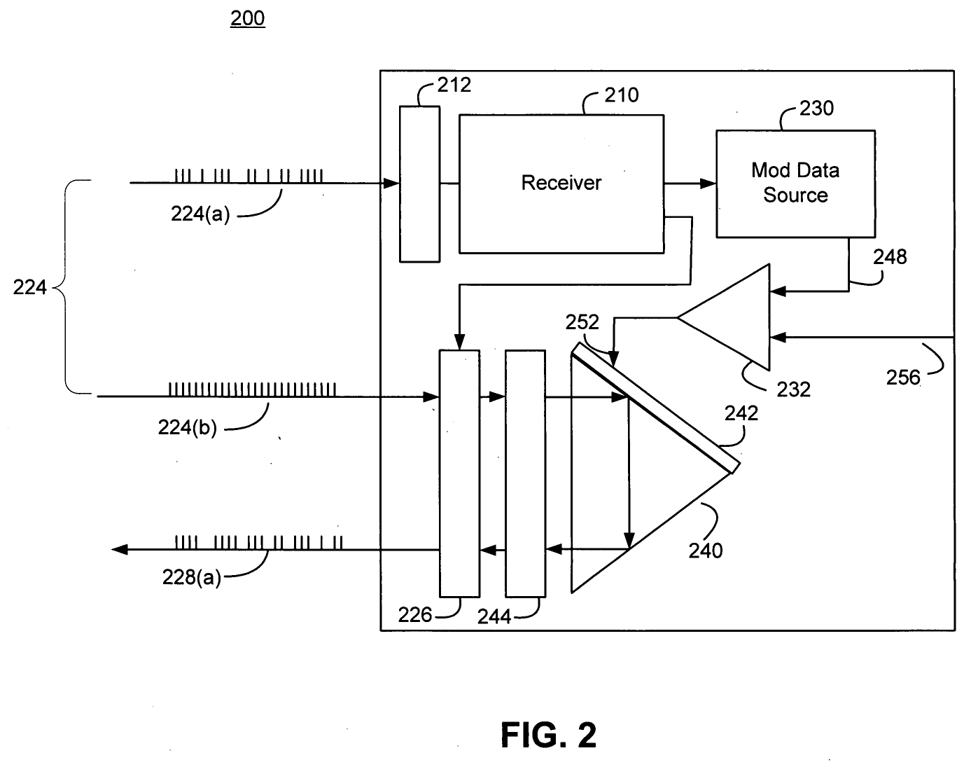

FIG. 2 is a functional block diagram illustrating the optical operation of an optical receiver having a MEMS retro-modulator in a second transceiver 200, such as the second transceiver of the system shown in FIG. 1. The second transceiver 200 is described as configured for an IFF system.

An incident transmit signal 224 can include a transmit code, such as a transmit code of the day (TCOD) 224(a). The transmit signal can include a frame-synchronization preamble (not shown) followed by a TCOD 224(a) followed by a TCOD interrogation pulse stream 224(b). In operation, TCOD 224(a) is received by one or more of the plurality of IR sensors 212 and presented to the challenge receiver 210 for verification. When TCOD 224(a) is verified, challenge receiver 210 can be configured to produce a shutter enable signal and a response code. The shutter enable signal can be coupled to a shutter 226 to control the shutter 226 to a transparent state. A filter 244 can also be positioned over the front surface of the corner cube reflector 240 to limit the background light incident on the corner cube reflector 240. The receiver 210 can be configured to generate the response code or can be configured to enable a modulation data source 230 configured to produce the response code.

The response code can include a response code of the day (RCOD) signal 248, which can include a logical combination of selected information from the TCOD 224(a) and from the local memory (not shown) of the challenge receiver 210 or within the modulation data source 230. The RCOD signal 248 can be coupled to a driver 232, which can produce a modulating signal 252 for modulating the response from the corner cube reflector 240.

A distinct enable signal 256, such as a biometric identification (ID) derived signal, can also be presented to the driver 232 to enable or disable operation thereof based on the verification of a scanned thumbprint input by the dismounted soldier in possession of helmet-mounted response unit. The RCOD signal 248 can includes a delay and a response pulse stream 228(a). The RCOD delay is typically sufficient to permit TCOD interrogation pulse stream 224(b) to be processed by the receiver 210. The corner cube reflector 240 can be modulated in accordance with the modulation signal 252 to produce response pulse stream 228(a) by reflecting selected elements of interrogation pulse stream 224(b) from the corner cube reflector 240 using a modulator 242 positioned on a reflecting surface of the corner cube reflector 240.

Corner Cube Reflectors (CCR) are pyramids with three internal reflective surfaces and a front entrance base. The reflective surfaces are joined with 90 degree angles at the apex of the pyramid. The base may have different shapes, for example a triangle, a square, a hexagon, a circle, and is referred to as a front surface. Many CCR applications have been used in satellite/deep space communication or in LCD display using visible light. A hollow CCR or solid glass CCR can be fabricated and can provide adequate performance for these applications.

A hollow CCR consists of an empty pyramid without a front surface. Incoming light bounces on the three surfaces before it is reflected back to the optical source. The maximum angle at which the incident beam can hit the CCR front surface and still be reflected is referred to as the Field of View (FOV). Typically, that angle is measured from the front surface normal axis and is defined as the maximum incident angle that defines a cone at which the reflected power is half of the power reflected at normal incident angle. For example, the FOV of a hollow CCR is ±18 degrees when illuminated with a 1550 nm source.

Unlike hollow CCRs, a solid glass CCR has a solid front surface. When the incident optical beam hits the front surface, the signal propagation path transitions from air with an index of refraction of n=1 to glass (BK7 for example) with an index of refraction of n=1.5. This slight increase in the index of refraction, n, causes the light to bend (be refracted) slightly toward the normal axis of the front surface. This slight bending makes the three internal surfaces to miss the refracted beam if the incident angle is greater than ±30 degrees when the CCR illuminated with 1550 nm.

Typical solid corner cube reflectors (CCRs) made of glass (such as BK-7) have a limited FOV of about ±30 degrees from a normal axis extending from the face of the corner cube reflector.

In a number of applications, such as Optical Combat Identification (ID) and Dynamic Optical Tags (DOTs), optical communications to a transponder consisting of CCRs and optical modulators operate over a coverage area of 360 degrees in azimuth and ±60 degree in elevation. Greater than seven BK-7 CCRs are needed to support such a coverage area.

In combat ID and DOTs applications, the cost, size and weight of transponders are of paramount importance, and therefore the number of CCRs per transponder must be minimized. Increasing the FOV of each CCR element can reduce the number of CCRs needed for a transponder to support communications over similar predetermined angle of incidence. In one embodiment, increasing the refractive index of the CCR material increases the FOV of the CCR.

The index of refraction of a material is generally defined at a desired operating wavelength. If the laser wavelength is at 1550 nm, a high index of refraction material such as Silicon (Si) or Indium Phosphate (InP) with an index of refraction of approximately 3.48 can increase the FOV to greater than approximately ±60 degrees. Of course, not all applications require or desire such a large field of view. In other applications, the index of refraction may be selected to achieve a field of view that is less than or greater than ±60 degrees. For example, the index of refraction can be selected to achieve a FOV that is greater than, for example, approximately ±25 degrees, ±30 degrees, ±35 degrees, or ±45 degrees.

Although the previous description focused on systems having an operating wavelength of 1550 nm and using Si or InP corner cube reflectors, other systems can use other operating wavelengths and may use other materials for the corner cube reflectors. Table 1 illustrates a variety of materials and their respective indices of refraction at a particular wavelength.

TABLE 1

| | | | Transmission |
|---|---|---|---|
| | Wavelength | Refractive | range |
| Infrared materials | μm | index | μm |
| Arsenic trisulphide | 1.00 | 2.4777 | 0.6 to 13 |
| | 10.00 | 2.3816 | |
| Barium fluoride | 0.546 | 1.4759 | 0.15 to 12.5 |
| | 10.346 | 1.3964 | |
| Cadmium telluride | 1.00 | 2.838 | 0.9 to ˜16 |
| (Irtran 6) | 10.00 | 2.672 | |
| Caesium bromide | 1.0 | 1.6779 | 0.22 to 55 |
| | 39.0 | 1.5624 | |
| Caesium iodide | 1.00 | 1.7572 | 0.25 to 55 |
| | 50.0 | 1.6366 | |
| Diamond | 0.546 | 2.4235 | ˜0.25 to >80 |
| Gallium arsenide | 10.0 | 3.135 | 1 to ˜15 |
| Germanium | 10.00 | 4.0032 | 1.8 to 23 |
| Lead fluoride | 0.55 | 1.7722 | 0.25 to ˜16 |
| | 10.00 | 1.6367 | |
| Magnesium oxide | 1.00 | 1.7227 | 0.3 to 7 |
| (Irtran 5) | 8.00 | 1.4824 | |
| Potassium bromide | 0.546 | 1.5639 | 0.23 to 25 |
| | 21.18 | 1.4866 | |
| Potassium chloride | 0.546 | 1.4932 | 0.21 to 20 |
| | 20.4 | 1.389 | |
| Potassium iodide | 0.546 | 1.6731 | ˜0.25 to ˜45 |
| | 20 | 1.5964 | |
| Silicon | 10.00 | 3.4170 | 1.2 to 10 |
| Silver chloride | 1.0 | 2.0224 | 0.4 to 30 |
| | 20.0 | 1.9069 | |
| Sodium chloride | 0.50 | 1.5516 | 0.2 to 20 |
| | 20.0 | 1.3822 | |
| Sodium fluoride | 0.546 | 1.3264 | 0.15 to 14 |
| | 10.3 | 1.233 | |
| Strontium | 0.56 | 2.4254 | 0.39 to 6.8 |
| titanate | | | |
| | 5.00 | 2.1221 | |
| Thallium bromo-iodide | 0.54 | 2.6806 | 0.6 to 40 |
| (KRS 5) | 30.0 | 2.2887 | |
| Zinc selenide | 1.00 | 2.485 | 0.45 to ˜21.5 |
| (Irtran 4) | 15.00 | 2.370 | |
| Zinc sulphide | 1.00 | 2.2907 | 1.0 to 14.5 |
| (Irtran 2) | 12.00 | 2.1688 | |
| Zinc sulphide | 0.546 | 2.3884 | 0.37 to 14 |
| (Cleartran) | 12.00 | 2.1710 | |

A transponder can implement as few as three Si or InP CCRs to support communications over 360 degrees in azimuth and 180 degrees in elevation or simply one to support ±120 deg FOV in elevation. An improved CCR FOV can result in a transponder implementation that uses one third the number of glass CCRs required to provide the same coverage.

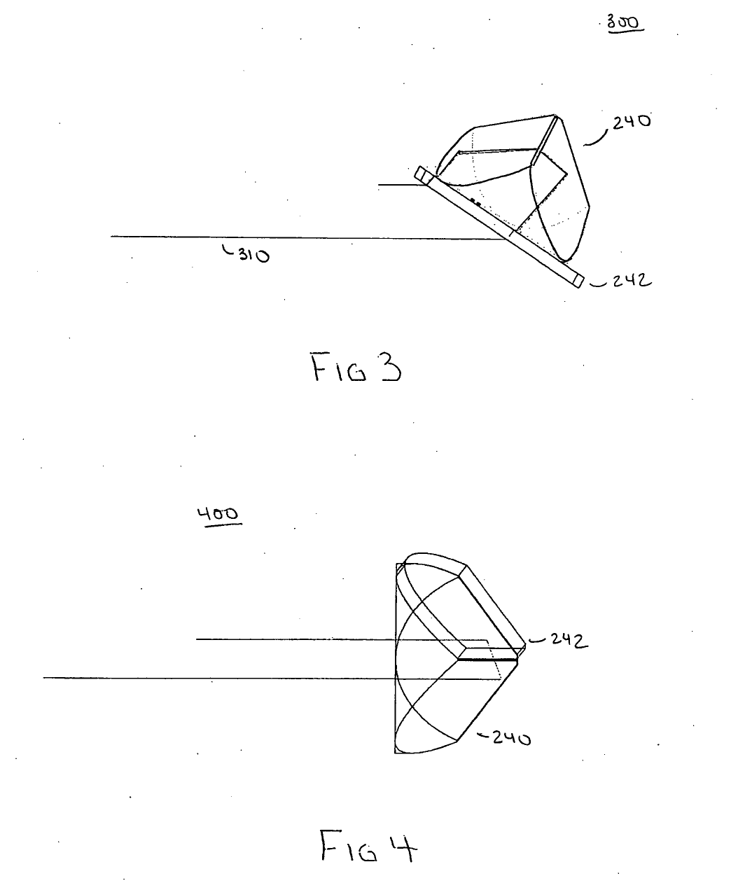

FIG. 3 illustrates an embodiment of a high-index (n>1.5) solid CCR 240 having three substantially triangular reflective surfaces joined at the apex with substantially 90 degrees angles. The front surface of the CCR 240 can be configured with a triangular, hexagonal or circular shape depending on the fabrication process and implementation, and is characterized by either the side length (d) of reflective surfaces or effective front circular diameter (D).

By using high-index material, such as Si or InP with index of refraction, n, of approximately 3.48, the CCR FOV can be increased from ±18 degrees (corresponding to a hollow CCR) and ±30 degree (for glass BK7 CCR) to ±60 degrees for Si or InP CCR when illuminated with 1550 nm wavelength. Therefore, substituting a solid Si or InP CCR for a glass or hollow CCR can improve wireless communication link performance by using fewer numbers of CCRs. The reduction in the number of CCRs can enable a more cost-effective, lighter and smaller size transponder/tag.

FIG. 3 illustrates an embodiment of a modulating retro-reflector 300 having a solid Si CCR 240 with a substantially circular front surface. The CCR 240 effective front surface dia meter D and height h can be optimized depending on the application. In terms of the CCR 240 side lengths d, D=0.816 d and h=0.577 d. For example, a 6.3 mm CCR 240 diameter corresponds to d=7.72 mm and a height h=4.45 mm.

When the incident optical beam hits the Si CCR 240 front surface, the signal propagation transitions from air with an index of refraction of n=1 to Silicon with an index of refraction of approximately n=3.48 at a wavelength of 1550 nm. This increase in n causes the light to bend or otherwise refract strongly towards the normal axis (more than in the glass n=1.5 CCR case). This bending or refraction causes the incident light to reflect off of the three internal surfaces and back towards the front surface at angles as large as ±60 degrees when the CCR 240 is illuminated with a 1550 nm source when the entrance aperture is fully illuminated.

In the embodiment of FIG. 3, a modulator 242 is positioned on the front entrance surface of the CCR 240. In this configuration, the modulator 242 operates in a transmissive mode as a shutter. The modulator 242 has effectively two states; a first state absorbing the optical signal (closed shutter, power OFF), and a second state passing the optical signal (open shutter, power ON). The modulator 242 area can be configured to be slightly larger than the CCR 240 front surface to preserve the relatively large field of view of the CCR 240 because of the finite thickness of the modulator.

The embodiment of FIG. 3 illustrates an example of an incident optical signal 310, such as a 1550 nm optical signal, arriving at an angle of approximately 60 degrees. The CCR 240 manufactured with a relatively high index of refraction material can result in the incident optical signal 310 refracting towards a normal axis of the CCR 240. The incident optical signal 310 is then reflected back from the CCR 240 along an axis that is substantially parallel to the angle of arrival. A CCR manufactured from a lower index of refraction material would not reflect the light long an axis substantially parallel to the angle of arrival. For a low index of refraction material, the large angle of arrival results in refraction of the incident signal to an angle that does not result in a reflection from the CCR.

FIG. 4 illustrates another embodiment of a modulating retro-reflector 400. The modulating retro-reflector 400 embodiment of FIG. 4 utilizes a modulator 242 operating in reflective mode. One or more modulators 242 can be positioned on one or more of three internal surfaces of the CCR 240 providing shuttering of the output signal by evanescent mode coupling. For a high index CCR 240 having n greater than about 1.5, for example n approximately 3.48, the effective FOV of the combined CCR 240 and modulator 242 can be maintained to ±60 degree for 1550 nm signals.

The large CCR FOV allows a fixed or moving optical source to locate and communicate with the Tag from long distances without requiring perfect alignment. The large FOV also permits operation in the presence of scintillation or source jitter. The large FOV CCR also permits a compact system design implementing CCRs. A transponder can use fewer Si or InP CCRs to cover the same area as supported by a larger number of glass CCRs.

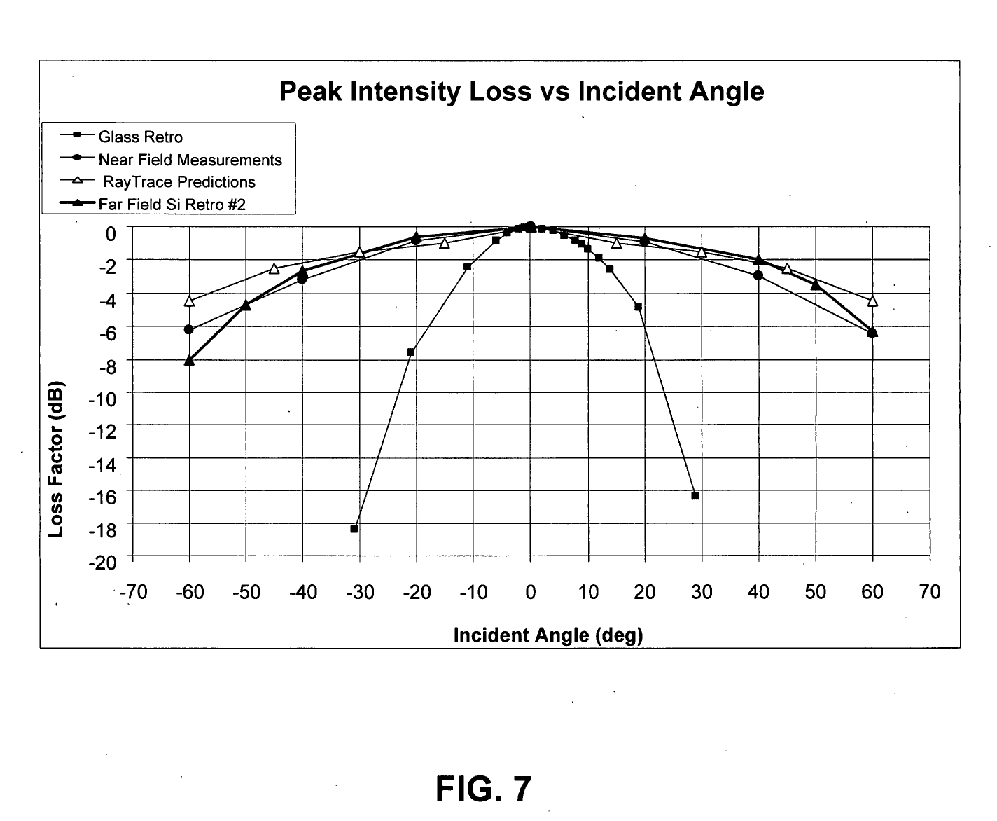

FIG. 7 is a graph illustrating peak intensity loss vs. incident angle for embodiments of corner cube reflectors. The graph illustrates the substantial difference in the FOV for different CCR embodiments. The graph illustrates two different CCR embodiments. A first embodiment is a glass CCR. A second embodiment, for which three characteristic curves are presented, is that of a solid Si CCR.

As can be seen from the figure, the FOV for the glass CCR is substantially narrower than the FOV for the solid Si CCR. The Si CCR can be used to provide a wider FOV than can be supported by a glass CCR, thereby allowing fewer CCRs to be used to support a given coverage area.

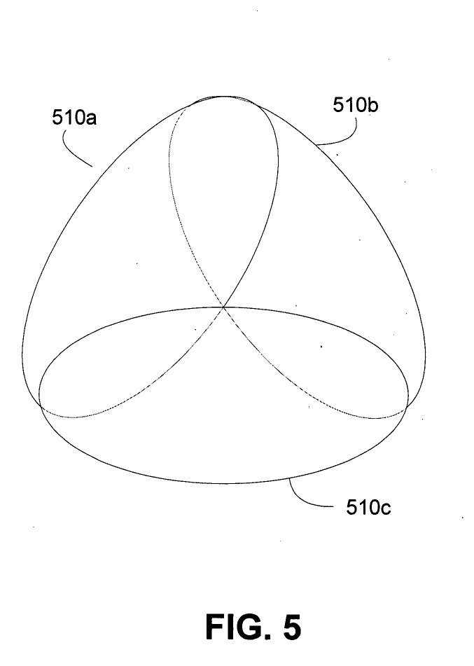

FIG. 5 is a simplified diagram of an embodiment of a corner cube implementation for a transponder configured to support a wide coverage area. In applications such as Optical Combat ID, a relatively large azimuth and elevation coverage area is required at the transponder. Support for a large coverage area can be achieved by using a cluster of multiple transponders containing modulating retro-reflectors.

FIG. 5 illustrates an embodiment of an implementation of modulating retro-reflectors 510a-510c configured to cover 360 degrees azimuth and 180 degrees elevation can implement as few as three high index CCRs, such as Si or InP CCRs. At least seven glass CCRs are needed to support the same coverage area. Therefore, by using the ±60 degrees FOV Si or InP CCR, the number of CCRs can be reduced to approximately three compared to seven of low index CCRs. The use of fewer modulating retro-reflectors translates into lower cost, smaller size and lighter transponder units.

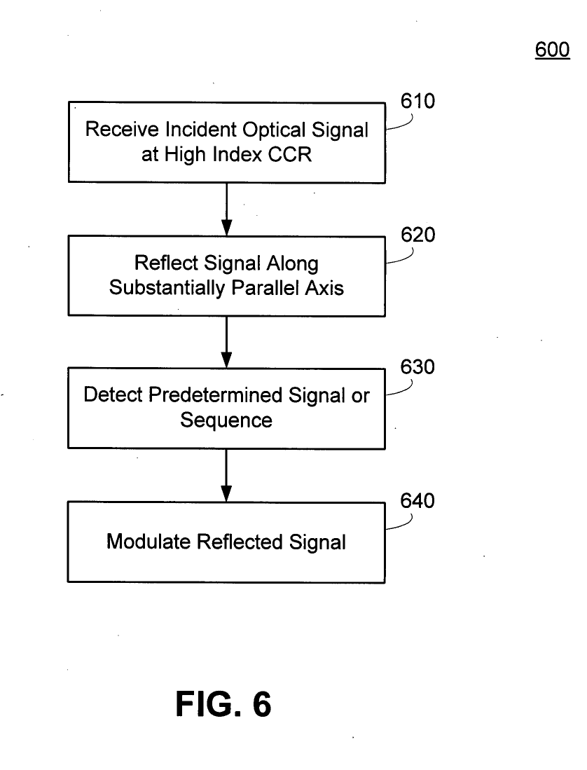

FIG. 6 is a simplified flowchart of a method 600 of operating a transponder or transceiver in an optical communication system utilizing retro-modulation. The method 600 can be performed, for example, by the tag of FIG. 1 or the transceiver of FIG. 2.

The method 600 begins at block 610 where the transceiver receives an incident optical signal at a high index corner cube reflector. The high index corner cube reflector can be one of a plurality of corner cube reflectors configured to support a predefined coverage area. For example, the corner cube reflector can be one of three corner cube reflectors having an index of refraction greater than about 3 and positioned to support a coverage area of 360 degrees azimuth and 180 degrees elevation.

The transponder proceeds to block 620 and reflects the received incident optical signal back along an axis substantially parallel to an axis defined by the incident optical signal. As described before, a corner cube reflector will reflect an incident optical signal back along an axis substantially parallel to the incident axis if the incident angle lies within the field of view of the corner cube reflector. In one embodiment, the face of the corner cube reflector can be unobstructed to allow an incident optical signal to be reflected. In another embodiment, the face of the corner cube reflector can be selectively occluded, such as with a shutter or modulator. In such an embodiment, the incident optical signal can be selectively reflected.

The transponder proceeds to block 630 and monitors the incident optical signal and determines whether the incident optical signal includes a predetermined signal or sequence. For example, the incident optical signal can be modulated with a predetermined signal or sequence, and an optical receiver in the transponder can detect a predetermined signal or sequence in the incident optical signal.

Upon detection of the predetermined signal or sequence, the transponder proceeds to block 640 and modulates the reflected signal with a locally generated modulation signal. The locally generated modulation signal can be, for example, a predetermined response signal or can be a data or information signal that is transmitted to a receiver at the optical source.

A high index of refraction corner cube reflector can be implemented with a modulator to produce a modulating retro-reflector having a substantially large field of view. The corner cube reflector can be manufactured as a solid corner cube reflector having a relatively high index of refraction. The corner cube reflector can be configured to have the relatively high index of refraction at a particular operating wavelength. The index of refraction can be generally greater than about 1.5. In one embodiment, the index of refraction is about 3.48 at 1550 nm. A corner cube reflector manufactured of Si or InP can have the desired attributes.

A transponder can be implemented with a plurality of modulating retro-reflectors positioned to support a predefined coverage area. In an embodiment where the transponder supports a coverage area a 360 degrees azimuth and 180 degrees elevation, the transponder can implement three modulating retro-reflectors using corner cube reflectors having an index of refraction of approximately 3.48.

Thus, the use of high index of refraction corner cube reflectors in a modulating retro-reflector can improve the angular acceptance performance of an optical communication system. Fewer modulating retro-reflectors can be used to support a predefined coverage area. The reduction in the number of modulating corner cube reflectors can result in a lower cost, lighter weight transponders.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

The steps of a method, process, or algorithm described in connection with the embodiments disclosed herein may be embodied directly in hardware, in a software module executed by a processor, or in a combination of the two. The various methods may be performed in the order shown in the embodiments or may be performed using a modified order of steps. Additionally, one or more process or method steps may be omitted or one or more process or method steps may be added to the methods and processes. An additional step, block, or action may be added in the beginning, end, or intervening existing elements of the methods and processes.

What is claimed is:

1. A modulating retro-reflector apparatus, the apparatus comprising:
a corner cube reflector comprising an index of refraction greater than approximately 1.5 at an operating wavelength; and
a modulator positioned relative to a face of the corner cube reflector and configured to modulate a signal incident on a face of the corner cube reflector.

2. The apparatus of claim 1, wherein the index of refraction is greater than about 3.0 at the operating wavelength.

3. The apparatus of claim 1, wherein the index of refraction is sufficiently high to achieve a corner cube reflector field of view greater than approximately ±30 degrees.

4. The apparatus of claim 1, wherein the corner cube reflector comprises Silicon material having at least one reflective surface.

5. The apparatus of claim 1, wherein the corner cube reflector comprises Indium Phosphate material having at least one reflective surface.

6. The apparatus of claim 1, wherein the corner cube reflector comprises a substantially solid corner cube reflector.

7. The apparatus of claim 1, wherein the modulator comprises a transmissive modulator positioned in front of an entrance face of the corner cube reflector.

8. The apparatus of claim 7, wherein the transmissive modulator includes an area greater than an area of the front entrance face of the corner cube reflector.

9. The apparatus of claim 1, wherein the modulator comprises a reflective modulator configured as a reflective surface for a reflective face of the corner cube reflector.

10. An optical transponder apparatus, the apparatus comprising:
a modulating retro-reflector (MRR) comprising a corner cube reflector having an index of refraction greater than about 3.0 at a wavelength of interest, and configured to selectively modulate an incident optical signal having the wavelength of interest;
an optical receiver configured to receive the incident optical signal and determine a presence of a predetermined signal; and
a modulator coupled to the optical receiver and configured to modulate the MRR when the optical receiver determines that the incident signal includes the predetermined signal.

11. The apparatus of claim 10, wherein the MRR comprises a solid corner cube reflector.

12. The apparatus of claim 10, wherein the MRR comprises a corner cube reflector consisting essentially of Silicon.

13. The apparatus of claim 10, wherein the MRR comprises a corner cube reflector consisting essentially of Indium Phosphate.

14. The apparatus of claim 10, wherein the MRR comprises a transmissive modulator positioned in front of an entrance face of the corner cube reflector.

15. The apparatus of claim 10, wherein the MRR comprises a reflective modulator positioned as a reflector for the corner cube reflector.

16. A method of operating a transponder in an optical communication system, the method comprising:
receiving an incident optical signal at an optical receiver;
determining a presence of a predetermined signal in the incident optical signal;
receiving an incident optical signal at the face of a corner cube reflector having an index of refraction greater than about 2.0; and
modulating the incident optical signal using a modulator positioned relative to a face of the corner cube reflector to produce a modulated reflected signal, if the predetermined signal is present in the incident optical signal.

17. The method of claim 16, wherein the incident optical signal comprises an optical signal having a wavelength of approximately 1550 nm.

18. The method of claim 16, wherein the corner cube reflector comprises a material having an index of refraction greater than 3.0 at a wavelength of 1550 nm.

19. The method of claim 16, wherein the corner cube reflector comprises a silicon material having at least one reflective surface.

20. The method of claim 16, wherein the corner cube reflector comprises an Indium Phosphate material having at least one reflective surface.

21. The method of claim 16, wherein the modulator comprises a transmissive modulator positioned in front of an entrance face of the corner cube reflector.

22. The method of claim 16, wherein the modulator comprises a reflective modulator positioned as a reflective face of the corner cube reflector.
